(19) United States
(12) Patent Application Publication
(10) Pub. No.: US 2016/0142370 A1
(43) Pub. Date: May 19, 2016

(54) SYSTEM AND METHOD FOR AUTOMATICALLY ADDRESSING DEVICES IN A MULTI-DROP MASTER/SLAVE NETWORK

(71) Applicant: SCHNEIDER ELECTRIC IT CORPORATION, West Kingston, RI (US)

(72) Inventors: Stephen Paul LINDER, Medford, MA (US); Bret Alan ORNER, Wellesley, MA (US)

(21) Appl. No.: 14/899,274

(22) PCT Filed: Jun. 28, 2013
(86) PCT No.: PCT/US2013/048596

§ 371 Date: Dec. 17, 2015

(51) Int. Cl. H04L 29/12

(52) U.S. Cl. CPC H04L 61/2053; H04L 61/2092; H04L 61/6004; H04L 61/6095

(57) ABSTRACT

A system for assigning communications addresses within a network is provided. The system comprises a memory and at least one processor coupled to the memory. The at least one processor coupled to the memory being configured to instruct each device of a plurality of devices to generate an identifier by transmitting a message to the plurality of devices using a default address, each device of the plurality of devices having an active address set to the default address instruct each device having an identifier within a range of identifiers to transmit a response including the identifier, and respectively assign a communications address to each device that transmits a response including a unique identifier.

### BACKGROUND

1. Technical Field

The technical field relates generally to communication between computerized devices and, more specifically, to systems and methods for addressing devices.

2. Background Discussion

Networking standards that employ a shared bus topology have a wide installed base in industrial applications. These networking standards include MODBUS, CAN, I²C and many radio based networks such as WLAN, ZigBee and Bluetooth. There are sundry reasons for the success of these networks, and some include ease of implementation, low cost of materials and robust performance in noisy, industrial settings. Of these standards, networks implementing MODBUS are particularly popular.

MODBUS is a byte-based communications protocol in which one device, referred to as a master device, drives communication with one or more other devices, referred to as slave devices. The specification for MODBUS defines an application layer supported by a physical/link layer. The application layer protocol is a general definition for exchanging data between a master device and one or more slave devices. Messages from the application layer are encapsulated in frames which are then transmitted across the physical/link layer. There are a number of different physical/link layer supported for MODBUS, including MODBUS ASCII/RTU.

Modes of communication available according to the MODBUS protocol include multicast messages and unicast messages. A multicast message is a message transmitted by a master device to all of the slave devices coupled to a network including the master device. Under a standard MODBUS implementation, slave devices do not respond to broadcasts. Multicast messages can be used to send data from the master device to all of the slave devices.

In contrast, unicast messages are initiated by a request message that is transmitted from the master device to a single slave device. Unicast messages are completed by a response message that is sent from the slave device back to the master device. Unicast messages can be used to send data from the master device to a specific slave device and to receive an acknowledgement at the master device, or to retrieve data from a slave device.

MODBUS ASCII/RTU is typically implemented on a RS-485 bus, and all of the devices coupled to the RS-485 bus may detect messages transmitted through the bus. MODBUS ASCII/RTU, therefore, uses addresses to uniquely identify each slave in the system. For unicast messages, the address of the slave targeted for a unicast message is included in the outgoing message and specifies which slave should receive, process and respond to the message. For broadcasts, a special reserved address is included in the outgoing message which identifies it as a broadcast to be received and processed by all of the slaves.

Devices that communicate via a shared bus topology are assigned addresses through a variety of methods. According to some methods, a person sets the address of a device by manually manipulating an element of the device, such as a dip switch. In other methods, a person configures the address of a device via a software application that stores the address within a memory located in the device. When configuring devices that communicate using a MODBUS protocol, such as MODBUS ASCII/RTU protocol, addresses are often configured during manufacture of the device or during its initial installation.

### SUMMARY

Aspects and examples of embodiments disclosed herein present apparatus and processes that assign communications addresses to one or more unassigned devices connected to a network configured in a shared bus topology. According to some examples, the address assignment process is conducted automatically by a controller that is in communication with the devices via a shared, multi-drop bus. In these examples, the controller conducts broadcast communications (e.g., multicast messages) or discrete, point to point transactions with the devices (e.g., unicast messages). Within the transactions, the controller provides communications addresses to devices within the network. Further, in these examples, the devices store the provided communications addresses in memory and configure themselves to recognize their communications addresses during network communications. Thus, aspects and examples disclosed herein ease the administrative burden associated with configuring devices for network communication and allow devices to be installed without specialized knowledge of address configuration procedures.

According to one example, the controller communicates with the devices via a shared RS-485 communications bus. In this example, each device has an active address set to a default address. The controller transmits a command to generate an identifier within a range of identifiers to all devices at the default address. Additionally, the controller transmits a command requesting devices with an identifier within a range of identifiers to respond with their respective identifiers. If the transmission of the identifiers to the controller is unsuccessful (e.g., there is a collision on the bus), multiple devices are present within the requested range and the size of the requested range is decreased. If the transmission is successful, only one device is present within the requested range and the uniquely identified device is assigned a unique communications address. This example is based on the MODBUS ASCII/RTU communications protocol, although it is not strictly compliant with this protocol as this example requires multiple devices at the same address to respond to the same request. However, since MODBUS ASCII/RTU does not specify any carrier-sense mechanism (i.e., a mechanism by which a host monitors the bus as it writes to it in order to detect collisions), each device may individually follow the MODBUS protocol. Therefore existing MODBUS implementations may employ this example to automatically generate device addresses.

According to one aspect, a system for assigning communications addresses within a network is provided. The system comprises a memory and at least one processor coupled to the memory and is configured to instruct each device of a plurality of devices to generate an identifier by transmitting a message to the plurality of devices using a default address, each device of the plurality of devices having an active address set to the default address instruct each device having an identifier within a range of identifiers to transmit a response including the identifier, and respectively assign a communications address to each device that transmits a response including a unique identifier.

According to one embodiment, the system is further configured to detect a collision on the network responsive to multiple devices of the plurality of devices transmitting responses within a predefined period of time. According to one embodiment, the range of identifiers includes a first range of identifiers and the system further comprises a second range of identifiers included within the first range of identifiers, wherein the system is further configured to instruct, responsive to detecting the collision, one or more devices having an identifier within the second range of identifiers to transmit a response. According to one embodiment, the system further comprises a third range of identifiers included within a difference between the first range of identifiers and the second range of identifiers, wherein the system is further configured to instruct, responsive to detecting the collision, one or more devices having an identifier within the third range of identifiers to transmit a response.

According to one embodiment, the system is further configured to instruct, responsive to receiving no response, each device having an identifier within the range of identifiers to transmit a response. According to one embodiment, the system is further configured to instruct, responsive to multiple devices generating an identical identifier, one or more devices to generate identifiers. According to one embodiment, the identifier includes at least one of a serial number, a microprocessor identifier, a number generated from a pseudo-random number generator and a number generated from a true random number generator.

According to one embodiment, each device of the plurality of devices comprises a memory storing an active address of the device within the network, the active address being set to the default address utilized by at least one other device in data communication with the network, and at least one processor coupled to the memory. The at least one processor coupled to the memory of each device being configured to receive at least one message sent to the default address including at least one instruction to generate an identifier within a set of identifiers, transmit the identifier, and change the active address to the communications address, generate an identifier within the set of identifiers responsive to receiving the at least one message including the at least one instruction to generate the identifier, transmit the identifier responsive to receiving the at least one message including the at least one instruction to transmit the identifier, and set the active address to the communications address responsive to receiving at least one message including the at least one instruction to change the active address to the communications address.

According to one aspect, a device is provided. The device comprises a memory storing an active address of the device within a network, the active address being set to a default address utilized by at least one other device in data communication with the network, and at least one processor coupled to the memory. The at least one processor coupled to the memory of the device being configured to receive at least one message sent to the default address including at least one instruction to generate an identifier within a set of identifiers, transmit the identifier, and change the active address to the communications address, generate an identifier within the set of identifiers responsive to receiving the at least one message including the at least one instruction to generate the identifier, transmit the identifier responsive to receiving the at least one message including the at least one instruction to transmit the identifier, and set the active address to the communications address responsive to receiving at least one message including the at least one instruction to change the active address to the communications address.

According to one embodiment, the at least one processor is further configured to set the active address to the default address responsive to detecting a data connection to a new network. According to one embodiment, the identifier includes at least one of a serial number, a microprocessor identifier, a number generated from a pseudo-random number generator and a number generated from a true random number generator. According to one embodiment, the identifier is a number and wherein the at least one processor is configured to generate random numbers based at least in part on the microprocessor identifier. According to one embodiment, the device communicates with one or more systems within the network using the MODBUS protocol.

According to one aspect, a computer-implemented method of assigning communications addresses using a computer, the computer including a memory and at least one processor coupled to the memory. The method comprises instructing, by the computer via a network, each device of a plurality of devices to generate an identifier by transmitting a message to the plurality of devices using a default address, each device of the plurality of devices having an active address set to the default address, instructing, by the computer via the network, each device having an identifier within a range of identifiers transmit a response including the identifier, and respectively assigning a communications address to each device that transmits a response including a unique identifier.

According to one embodiment, the method further includes detecting a collision on the network, responsive to multiple devices of the plurality of devices transmitting responses with a predefined period of time. According to one embodiment, the range of identifiers includes a first range of identifiers and the method further includes instructing, responsive to detecting the collision, one or more devices having an identifier within a second range of identifiers to transmit a response, the second range of identifiers included within the first range of identifiers. According to one embodiment, the method further includes instructing, responsive to detecting the collision, one or more devices having an identifier within a third range of identifiers to transmit a response, the third range of identifiers included within a difference between the first range of identifiers and the second range of identifiers.

According to one embodiment, the method further includes instructing, responsive to receiving no response, each device having an identifier within the range of identifiers to transmit a response. According to one embodiment, the method further includes instructing, responsive to multiple devices generating an identical identifier, one or more devices to generate identifiers. According to one embodiment, instructing each device of the plurality of devices to generate an identifier includes instructing each device of the plurality of devices to generate at least one of a serial number, a microprocessor identifier, a number generated from a pseudo-random number generator and a number generated from a true random number generator.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of any particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a functional schematic of one example of an address assignment system;

FIG. 2 is a functional schematic of one example of a computer system that may perform processes and functions disclosed herein;

FIG. 3 is a flow diagram depicting a process of automatically assigning addresses to target devices;

FIG. 4 is a flow diagram illustrating a process of establishing an auto-addressing session;

FIG. 5 is a flow diagram illustrating a process of conducting an auto-addressing round;

FIG. 6 is an execution diagram depicting a process of configuring a target device to use an assigned communications address;

FIG. 7 is a flow diagram depicting a process of configuring a target device to use an assigned address; and

FIG. 8 is a flow diagram illustrating a process for initializing an auto-addressing session.

### DETAILED DESCRIPTION

In at least one example, an address source device (e.g., master device) coupled to one or more address target devices (e.g., slave devices) via a shared bus network implements an interface through which the source device receives an indication to initiate an address assignment process. The interface includes hardware and software configured to receive the indication from an external entity, such as a user or an external system. Upon receipt of the indication, the interface executes the address assignment process. The address assignment process assigns communications addresses to the target devices from a predefined set of addresses, referred to as an “address space,” that are compatible with the communication protocol utilized by the shared bus network.

In some examples, the target devices are capable of detecting when they are connected to a new network. The target devices may then set their active address to a default address, already known to the source device, to use for communication with the source device during the address assignment process. Multiple target devices may operate simultaneously using the default address. According to some examples directed to a network employing the MODBUS protocol, the address assignment process is triggered by a user through a user interface. According to these examples, once triggered, the address assignment process begins with a command transmitted to target devices using the default address. The command instructs all target devices using the default address to generate an identifier within a pre-defined range of identifiers.

The use herein of the term “command” refers to messages transmitted from the source device to one or more target devices. These messages may be communicated as a transaction (i.e., a message sent from the source device to a specific address) or as a broadcast communication (i.e., a message from the source device to all of the target devices on the network) that contains information to selectively identify target devices to perform the action in the broadcast message. For example, the source device may transmit a broadcast message to all of the target devices that includes information identifying one or more target devices and instructions for the identified one or more target devices to perform an action. The target devices may receive the broadcast information and match the received target device identifying information from the broadcast message with their own respective identifying information. If the identifying information matches, the target device performs the instructions in the broadcast message. Otherwise, the target device ignores the instructions in the broadcast message. Some embodiments transmit messages as transactions to limit the amount of extraneous processing performed by target devices on the network that already have assigned communications addresses.

The identifier generated by each target device, in response to receiving a command to do so by the source device, may be a random, or pseudo-random, number. Various examples use a variety of random number generators to generate identifiers. For instance, according to one example, an autonomous linear feedback shift register (ALFSR), which is an algorithm based on Galois finite fields, is used. In this example, the state of an ALFSR is buffered on each iteration, and bits are drawn sequentially from the buffer as needed for multiple outputs of the pseudo-random number generator. Further, in this example, the ALFSR is not iterated again until the buffer is empty. This procedure helps increase the “randomness” of the ALFSR based pseudo-random number generator.

In one example, the address assignment process proceeds with one or more rounds of auto-addressing. The goal of each round is to find target devices with a unique identifier and assign the target device a communications address. Each round of the address assignment process proceeds as follows. The source device iterates through every identifier within the range of identifiers. This iterative process may include breaking the range of identifiers into a plurality of sub-ranges and requesting a response from any target device within the sub-range of the range of identifiers. Any target device that has chosen an identifier within the requested range responds with the value of their identifier. If the source device receives no response to the request range command, the source device determines that no target device has generated an identifier within the range requested.

If the source device receives a “garbled” response (e.g., the response fails a CRC validity check), the source device determines that more than one target device has adopted an identifier within the requested range. This determination is made because a garbled response is indicative of a collision generated by more than one target device communicating on the shared bus at the same time. Since, in this instance, more than one target device has adopted an identifier within the requested range, the source device cannot effectively uniquely identify each responding target device. Upon this condition, the source device divides the requested range into multiple sub-ranges and repeats the search process.

If the source device receives a valid response (e.g., the response passes the CRC validity check), the source device transmits a command to the default address identifying a single target device by its identifier. In response receiving the command, the target device sets its active address to the communications address included in the command. The target device is removed from the pool of unassigned target devices and need not participate in the subsequent rounds of the address assignment process. Once the source device iterates through all the identifiers within the range of identifiers and does not detect any collisions, the round is over.

This example of the address assignment process ends when there are no target devices remaining with active addresses set to the default address. The source device makes this determination by transmitting a command to the all of the target devices using the default address requesting a response and subsequently not receiving any responses (garbled or otherwise).

This example manifests an appreciation that, while some communications protocols, such as the Internet Protocol, allow devices to request a communications address, other communications protocols, such as MODBUS, do not. Therefore an address assignment protocol that requires target devices to initiate address assignments with a server, such as DHCP, cannot be used on a MODBUS network because target devices cannot initiate a transaction to announce their presence on the bus. Furthermore, this example reflects an understanding that unique device identifiers (e.g., device serial numbers) typically cannot be used as MODBUS addresses because the MODBUS address space is smaller than an address space made up of potential unique device identifiers (e.g., device serial numbers) under most serial number assignment schemes.

Examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Address Assignment System

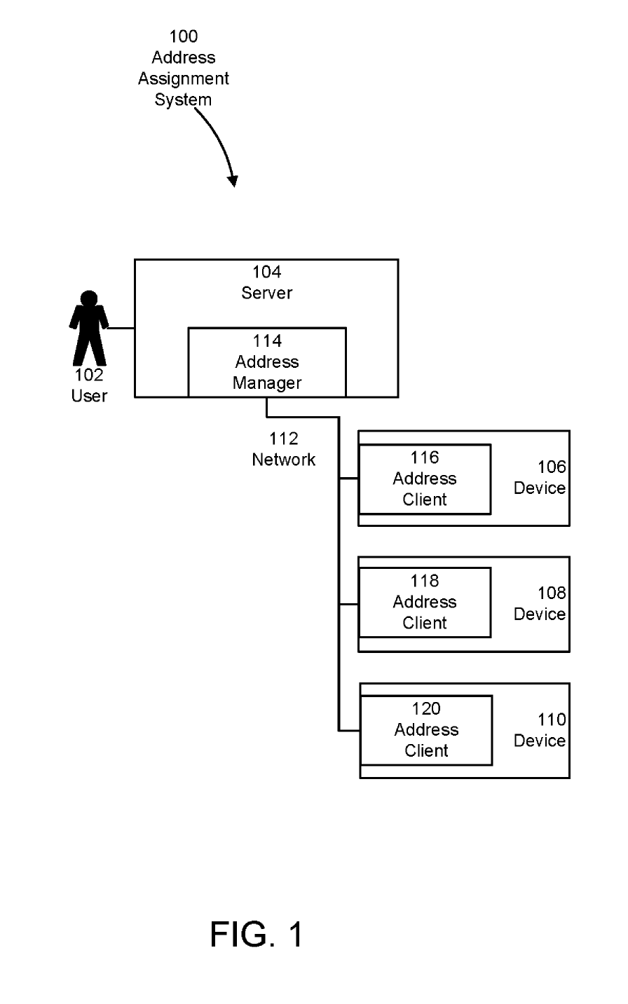

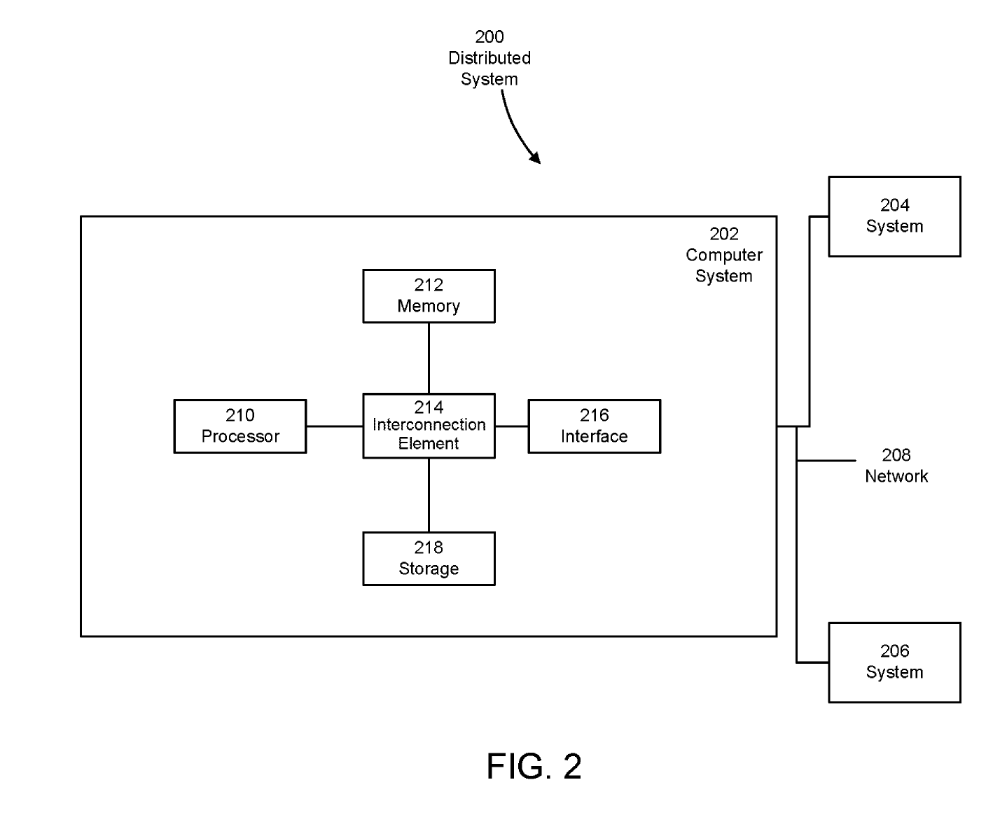

Various examples disclosed herein implement an address assignment system on one or more computer systems. FIG. 1 illustrates one of these examples, an address assignment system 100. As shown, the address assignment system 100 includes a user 102 and a server 104 coupled to devices 106, 108 and 110 via a network 112. In the illustrated example, the server 104 is implemented using a computer system, such as the computer systems discussed further below with reference to FIG. 2. In some examples, the devices 106, 108 and 110 are also computer systems. As shown, the server 104 includes an address manager 114 and the devices 106, 108 and 110 include address clients 116, 118 and 120, respectively.

In other examples, the devices 106, 108 and 110 include computing resources, but primarily function as devices other than computer systems. For instance, in these examples, the devices 106, 108 and 110 may be uninterruptible power supplies, current transformers or smart batteries, and wireless ZigBee devices, among others. Thus, in these examples, the computing resources included in the devices 106, 108 and 110 are limited and are tailored to support the operation of the devices.

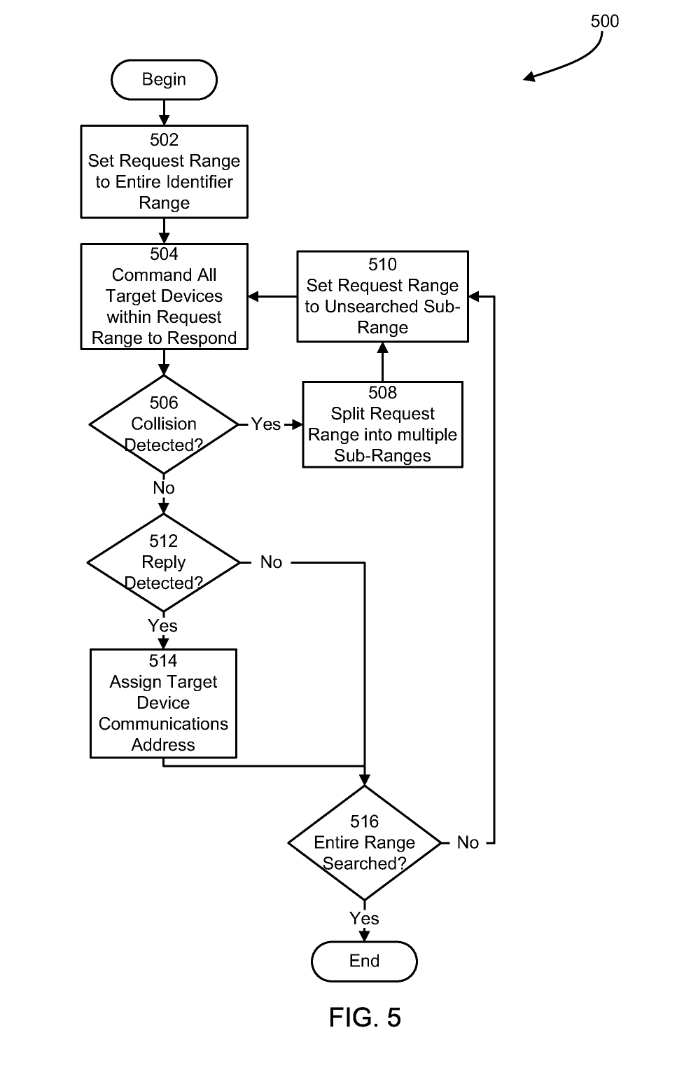

The network 112 may include any communication network through which a computer system may send or provide information. For example, the network 112 may be a public network, such as the internet, and may include other public or private networks such as LANs, WANs, extranets and intranets. In some examples, the network 112 utilizes a shared network bus and employs standards that are well suited for industrial or residential applications. Some of these networking standards include communication protocols such as C-BUS™ and TCP/IP over Ethernet, serial protocols, such as MODBUS ASCII/RTU, DMX512 and JCI-N2. In other examples, the network 112 utilizes a wireless bus and implements wireless protocols, such as ZigBee and Bluetooth. For instance, according to one example, the servers 104 and the devices 106, 108 and 110 are respectively a master CT module and slave CT modules that communicate via a wireless bus such as the master CT module 502 and the slave CT modules 504 as described with reference to FIG. 5 in co-pending U.S. patent application Ser. No. 12/789,922, entitled SYSTEM AND METHOD FOR MONITORING ELECTRICAL CURRENT AND POWER USAGE, filed May 28, 2010, which is incorporated by reference herein in its entirety. Further, in at least one example, the network 112 includes a half-duplex medium that allows for only one device to issue commands within a given period of time. Further, according to this example, the network 112 does not necessarily include collision detection and avoidance facilities.

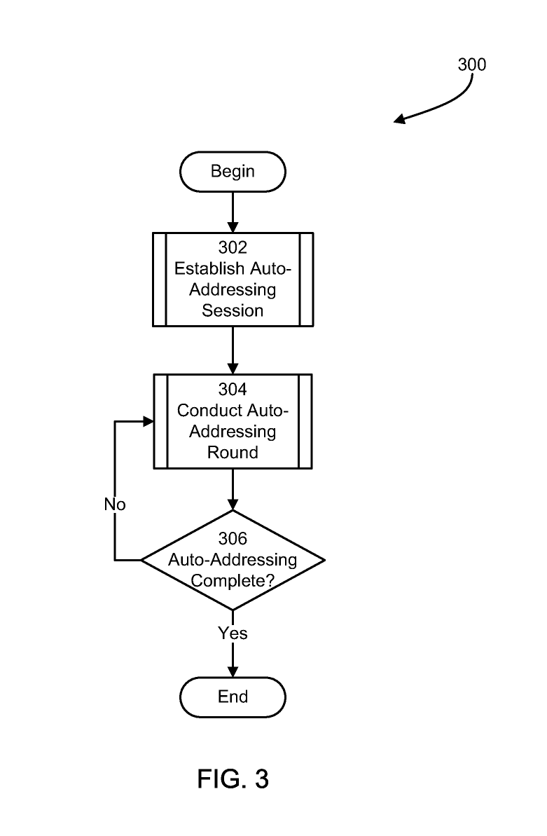

As shown, the server 104 is employed by a user 102 to assign addresses to the devices 106, 108 and 110 via the network 112. In particular, a user interface component resident on the server 104 provides a user interface through which the address manager 114 receives address assignment requests from the user 102. In various examples, the address assignment requests include information required to execute a variety of automatic address assignment processes, which are described further below with reference to FIGS. 3-8. Depending on the particular automatic address assignment processes requested, the required information may include information indicating devices targeted for automatic address assignment and a set of addresses belonging to an address space to be used by the target devices during normal operation. In at least one example, this user interface component is included in the address manager 114.

The address manager 114 processes address assignment requests by conducting one or more automatic address assignment processes. More particularly, in some examples, the address manager 114 implements a system interface through which the address manager exchanges and processes configuration messages with the address clients 116, 118 and 120. Particular examples of the automatic address assignment processes conducted by the address manager 114 are described further below with reference to FIGS. 3-8.

In another example, an intermediate device is located within the network 112 and in-between the server 104 and the devices 106, 108 and 110. According to this example, the user interface component is not included in the address manager 114. Rather, according to this example, the user interface component is a stand-alone component resident on the server 104 and the address manager 114 is resident on the intermediate device. Further, according to this example, the server 104 provides the address assignment requests to the address manager 114 and, as discussed above, the address manager 114 provides address information to the target devices.

With continued reference to the example of FIG. 1, the address clients 116, 118 and 120 each automatically configure communications addresses for the devices 106, 108 and 110, respectively. More particularly, the address clients 116, 118 and 120 each implement a system interface through which each address client exchanges and processes configuration messages from the address manager 114. The specific communication messages exchanged and processed vary depending on the automatic address assignment process being conducted by the address manager 114. At least one exemplary process conducted by each of the address clients 116, 118 and 120 is discussed further below with regard to FIGS. 3-8.

Information may flow between these components, or any of the elements, components and subsystems disclosed herein, using a variety of techniques. Such techniques include, for example, passing the information over a network using standards protocols, such as MODBUS, passing the information between modules in memory and passing the information by writing to a file, database, data store, or some other non-volatile data store device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the examples disclosed herein.

In addition, examples of the address assignment system 100 may include a variety of hardware and software components configured to perform the processes and functions described herein, and examples are not limited to a particular hardware component, software component or combination thereof. For instance, according to some examples, the address assignment system 100 is implemented using a distributed computer system. An example of one such distributed computer system is discussed further below with regard to FIG. 2.

Information, including address information within address assignment requests and responses, may be stored on the server 104 or the device 106, 108 and 110 in any logical construction capable of storing information on a computer readable medium including, among other structures, flat files, indexed files, hierarchical databases, relational databases or object oriented databases. The data may be modeled using unique and foreign key relationships and indices. The unique and foreign key relationships and indices may be established between the various fields and tables to ensure both data integrity and data interchange performance.

The interfaces disclosed herein, which include both system interfaces and user interfaces, exchange (i.e. provide or receive) information with various providers and consumers. These providers and consumers may include any external entity including, among other entities, users and systems. Each of the interfaces disclosed herein may both restrict input to a predefined set of values and validate any information entered prior to using the information or providing the information to other components. Additionally, each of the interfaces disclosed herein may validate the identity of an external entity prior to, or during, interaction with the external entity. These functions may prevent the introduction of erroneous data into the address assignment system 100 or unauthorized access to the address assignment system 100.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 2, there is illustrated a block diagram of a distributed computer system 200, in which various aspects and functions are practiced. As shown, the distributed computer system 200 includes one more computer systems that exchange information. More specifically, the distributed computer system 200 includes computer systems 202, 204 and 206. As shown, the computer systems 202, 204 and 206 are interconnected by, and may exchange data through, a communication network 208. The network 208 may include any communication network through which computer systems may exchange data. To exchange data using the network 208, the computer systems 202, 204 and 206 and the network 208 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 202, 204 and 206 may transmit data via the network 208 using a variety of security measures including, for example, TLS, SSL or VPN. While the distributed computer system 200 illustrates three networked computer systems, the distributed computer system 200 is not so limited and may include any number of computer systems and computing devices, networked using any medium and communication protocol.

As illustrated in FIG. 2, the computer system 202 includes a processor 210, a memory 212, an interconnection element 214, an interface 216 and data storage element 218. To implement at least some of the aspects, functions and processes disclosed herein, the processor 210 performs a series of instructions that result in manipulated data. The processor 210 may be any type of processor, multiprocessor or controller. Some exemplary processors include commercially available processors such as an Intel Xeon, Itanium, Core, Celeron, or Pentium processor, an AMD Opteron processor, an Apple A5, a Sun UltraSPARC or IBM Power5+ processor and an IBM mainframe chip. The processor 210 is connected to other system components, including one or more memory devices 212, by the interconnection element 214.

The memory 212 stores programs and data during operation of the computer system 202. Thus, the memory 212 may be a relatively high performance, volatile, random access memory such as a dynamic random access memory (“DRAM”) or static memory (“SRAM”). However, the memory 212 may include any device for storing data, such as a disk drive or other non-volatile storage device. Various examples may organize the memory 212 into particularized and, in some cases, unique structures to perform the functions disclosed herein. These data structures may be sized and organized to store values for particular data and types of data.

Components of the computer system 202 are coupled by an interconnection element such as the interconnection element 214. The interconnection element 214 may include one or more physical busses, for example, busses between components that are integrated within a same machine, but may include any communication coupling between system elements including specialized or standard computing bus technologies such as IDE, SCSI, PCI and InfiniBand. The interconnection element 214 enables communications, such as data and instructions, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and to communicate with external entities, such as users and other systems.

The data storage element 218 includes a computer readable and writeable nonvolatile, or non-transitory, data storage medium in which instructions are stored that define a program or other object that is executed by the processor 210. The data storage element 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage element 218. The memory may be located in the data storage element 218 or in the memory 212, however, the processor 210 manipulates the data within the memory, and then copies the data to the storage medium associated with the data storage element 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having a different architectures or components than that shown in FIG. 2. For instance, the computer system 202 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Automatic Addressing Processes

As discussed above, some examples perform processes that result in communications addresses being assigned to one or more devices via a network. More specifically, according to one example, a device, such as the server 104, includes one or more components, such as the address manager 114, that perform a process to assign communications addresses to one or more other devices, such as the devices 106, 108 and 110. FIG. 3 illustrates an example of a process 300 of automatically assigning addresses to target devices. As shown, the assignment process 300 includes acts of establishing an auto-addressing session 302, conducting an auto-addressing round 304, and determining if the auto-addressing process is complete after each auto-addressing round 306.

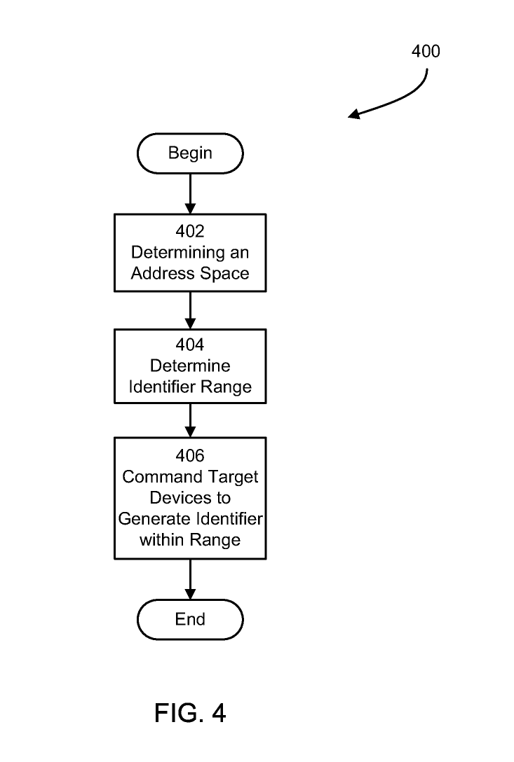

In act 302, an auto-addressing session is established between a source device that controls the address assignment process and one or more target devices coupled to a network. In at least one example, the source and target devices are specified in an address assignment request that is entered by the user 102 or provided by an external system. According to another example, the source device performs initialization and allocation functions that enable the source device to support the address assignment process disclosed herein. In this example, the source device also provides a portion of the information generated during initialization to the target devices. One example process to establish an auto-addressing session performed in the act 302 is illustrated by process 400 discussed further below with reference to FIG. 4.

In act 304, an auto-addressing round is conducted. In some examples, a source device conducts an auto-addressing round by attempting to assign addresses to the target devices. One example of an auto-addressing round process performed in the act 304 is illustrated by process 500 discussed further below with reference to FIG. 5.

In act 306, it is determined whether the auto-addressing process is complete. According to at least one example, the source device makes this determination by transmitting a command to the target devices having an active address set to the default address requesting that all target devices respond with their respective unique identifiers. The source device then detects whether any response including a collision occurred. If any response is received from a target device, the source device determines that the auto-addressing process is not complete and initiates an additional auto-addressing round 304. Otherwise, the source device terminates process 300. It is appreciated that, in at least one example, the source device may limit the number of auto-addressing rounds executed to a predetermine number to prevent the possibility of a runaway system (e.g., the system going into an infinite loop).

In another example, the source device periodically determines if any target devices remain at the default address. Otherwise, the source device terminates the process 300. The source device makes this determination by requesting the generation and transmission of an identifier from all of the target devices having an active address set to the default address. If the source device receives a message, garbled or otherwise, one or more unassigned target devices remain at the default address. Address assignment processes in accord with the process 300 enable source devices to efficiently and effectively configure target devices with communications addresses that are used during normal operation of the target devices.

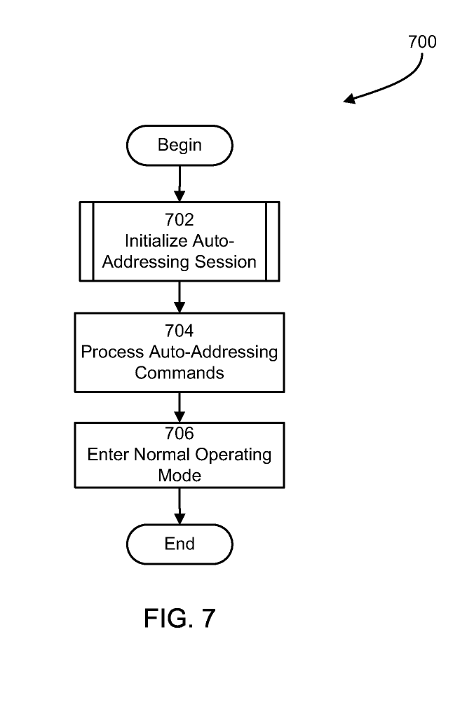

To receive the communications address assignments provided through execution of the process 300, target devices, such as the devices 106, 108 and 110, include at least one component, such as the address clients 116, 118, 120, that performs a process 700 that is reciprocal to the process 300. One example process of configuring a target device to use an assigned address is illustrated by process 700 with reference to FIG. 7. As shown, the process 700 includes acts of initializing an auto-addressing session 702, processing auto-addressing commands 704, and entering a normal operating mode 706.

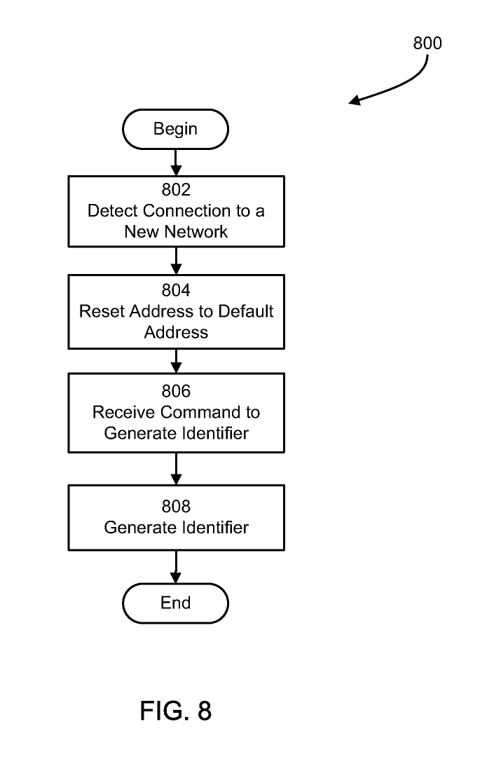

In act 702, an auto-addressing session is initialized on the target device. In one example, the target device is capable of recognizing network changes including when it has been added to a new network. The target device may automatically change its active address to the default address upon recognition that it is connected to a new network (e.g., a network with a new source device). In other examples, the active address of new target devices is set to the default address during the manufacturing process of the target device. The target device may then receive initialization information from the source device, and the target device may process the initialization information to prepare itself to receive communications address information from the source device. The initialization information may include commands instructing the target device to generate a random number within a pre-defined range of values. One example of a process performed in the act 702 is discussed further below with reference to FIG. 8.

In act 704, auto-addressing commands are processed by the target device. In one example, the target device is configured to use an assigned communications address by receiving, processing and responding to auto-addressing commands. The auto-addressing commands may include commands requesting a response if the target device has an identifier within the request range. The target device may respond to the incoming auto-addressing command from the source device with its identifier if it is within the requested range. The target device may then receive a command containing a communications address from the source device. In response to receiving the command, the target device stores the communications address as its active address to use for normal operation.

In act 706, a normal operating mode is entered. According to at least one example, after establishing a communications address to be used during normal operation, the target device enters a normal operating mode in which it communicates on the networking using the communications address. Address assignment processes in accord with the process 700 enable target devices to be efficiently and effectively configured with addresses that are used during normal operation of the target devices, thereby avoiding the cost, difficulty, and error associated with manual configuration processes.

### Source Device Processes

As discussed above with reference to the act 302 of the process 300, in some examples, a source device, such as the server 104, establishes an auto-addressing session with one or more target devices. FIG. 4 illustrates an exemplary process 400 of establishing an auto-addressing session that may be implemented by the source device to achieve this purpose. As shown, the process 400 includes acts of determining an address space 402, determining an identifier range 404, and commanding target devices to generate an identifier 406.

In act 402, the source device determines one or more address spaces utilized during the automatic address assignment process. According to one example, the source device identifies a set of addresses that may be used to communicate with target devices according to the network protocols employed on a network. Once this address space is identified, the source device identifies the default address for the new target devices. In one example, the default address for the new target devices is pre-programmed into the source device.

In act 404, the source device determines an identifier range within which target devices may generate an identifier. The range of identifiers may be selected to be greater than or equal to the number of possible addresses in the address space and subsequently the number of devices that can be assigned to the source device. In at least one example, the range is pre-programmed into the source device. For example, the communication protocol used by the source and target devices may support up to 240 unique target device addresses. In this example, the range of identifiers may be programmed to be from 0 to 65,535 or equivalently any 16-bit unsigned integer value.

Next, in act 406, the source device issues an instruction to the unassigned target devices having an active address set to the default address requesting that all target devices generate an identifier within the identifier range communicated in the command. Upon completion of the process 400, the source device is ready to begin automatic assignment of communications addresses to the target devices.

As discussed above with reference to the act 304 of the process 300, in some examples, a source device, such as the server 104, conducts an auto-addressing round in which the source device assigns communications addresses to one or more target devices. FIG. 5 illustrates an exemplary process 500 of conducting an auto-addressing round that may be implemented by the source device to achieve this purpose. As shown, the process 500 includes several acts, each of which is discussed further below.

In act 502, the source device sets the request range to the entire identifier range. In act 504, the source device sends a command to all of the target devices within the request range. The target devices process the command to match their respective identifiers with the identifier range in the command. If the identifier of the target device matches the identifier range in the command, the target device transmits a response including its identifier. Otherwise, the target device does not respond. In the event that multiple devices respond to the command sent by the source device, a collision on the bus will occur. In act 506, the source device determines whether a collision on the bus was detected. If a collision on the bus was detected, the source device proceeds to act 508. Otherwise, the source device proceeds to act 512.

In act 508, the source device splits the request range into multiple sub-ranges. The request range, for example, may be split into two equal halves consistent with a binary search and thereby form two new sub-ranges. The source device proceeds to act 510 where the source device sets the request range to a new sub-range. The source device then performs the act 504 as previously described.

It is appreciated that the request ranges may be split in the act 508 consistent with other search methodologies such as, but not limited to, a linear search. In addition, the ranges do not have to be split into sub-ranges of equal size. The ranges may be split into varying sizes based upon a probability of the identifiers being within the sub-range. For example, the identifiers of the target devices may be equally likely to be within the smaller range of 0-50 as the larger range 51-255. Accordingly, the source device may split the range of 0-255 into two unequal sections (i.e., 0-50 and 51-255). In the event that multiple source devices generate the same identifier value, the source device may repeat the command to the target devices to generate an identifier within a range of identifier values as described by the act 406 with reference to FIG. 4. The range of identifier values may be increased when act 406 is repeated to decrease the likelihood of repeated identifiers.

In act 512, the source device determines whether a reply was detected from its original command transmitted to all target devices having an active address set to the default address. If a reply was detected in act 512, the source device may proceed to act 514 and assign the uniquely identified target device with a communications address. Otherwise, the source device proceeds to act 516. In act 516, the source device determines if the entire range and all sub-ranges of identifiers have been searched. If the entire range and all sub-ranges have been searched, the auto-addressing round terminates. Otherwise, the source device continues to step 510 to set the request range and continue the process 500.

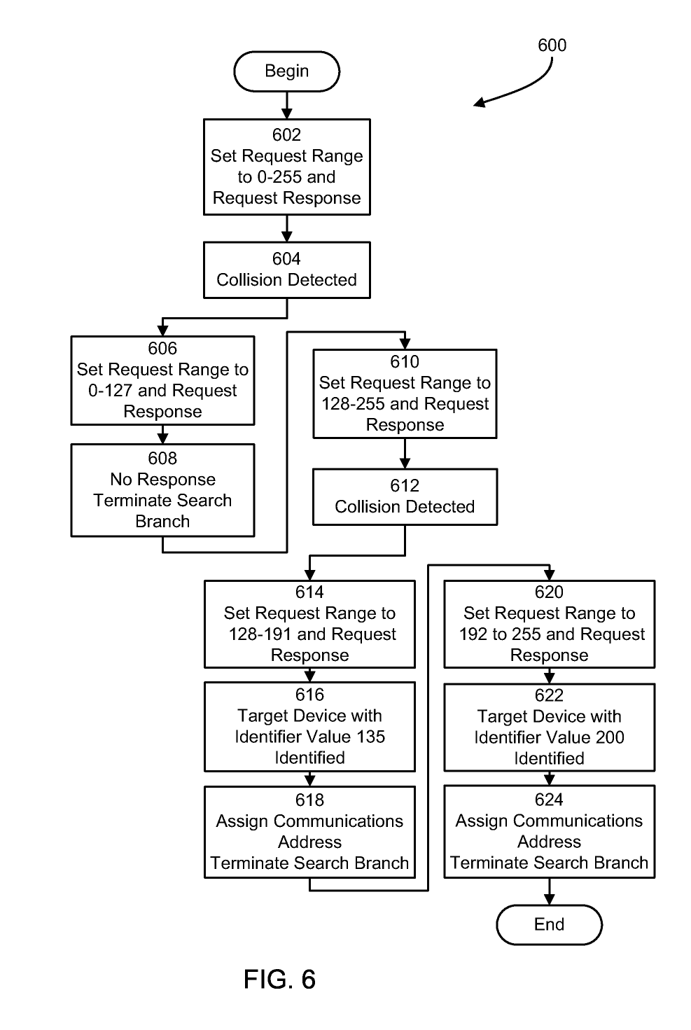

FIG. 6 illustrates a possible execution diagram created through the acts of FIG. 5 implemented with a binary search algorithm locating two newly added target devices to the network. In this example, the entire range of identifiers is any value including or between 0 and 255, any 8-bit unsigned integer. The source device initially sets the request range to the entire range of identifiers. In activity 602, the source device requests a response from the entire request range. The source device then detects a collision on the bus caused from multiple target devices attempting to respond to the source device simultaneously. The source device proceeds to split the request range into a first sub-range (e.g., 0-127) and a second sub-range (e.g., 128-255). In activity 606, the source device may proceed to set the request range to the first sub-range. In activity 608, the source device does not receive any responses and terminates the search branch. The source device then proceeds to activity 610 and sets the request range to the second sub-range. The source device then detects a collision on the bus in activity 612. The source device proceeds to further split the second sub-range into a third sub-range (e.g., 128-191) and a fourth sub-range (e.g., 192-255). The source device proceeds in activity 614 to set the request range to the third range and request a response from target devices within the third range. The source device receives a command in activity 616 from a single target device with an identifier value of 135. The source device then assigns the target device a communications address as seen in activity 618. The source device proceeds to activity 620 and sets the request range to the fourth request range and requests a response from devices with active address within the fourth request range. The source device receives a response in activity 622 from a source device with an identifier value of 200. The source device assigns a communications address to the uniquely defined target address and terminates the search branch.

### Target Device Processes

As discussed above with reference to the act 702 of the process 700, in some examples, a target device, such as any of the devices 106, 108 and 110, initializes an auto-addressing session. FIG. 8 illustrates an exemplary process 800 for initializing an auto-addressing session that may be implemented by the target device to achieve this purpose. As shown, the process 800 includes acts of detecting a connection to a new network 802, resetting the address to a default address 804, receiving a command to generate an identifier 806 and generating an identifier 808.

In act 802, the target device detects a connection to a new network. In one example, the target device automatically sets its active address to the default address when the device loses power (e.g., the device is disconnected from a first network and connected to a second network). In other examples, the target device stores a unique identifier associated with the source device in memory. In these examples, the source devices broadcast their associated unique identifier to all of the target devices. The target devices receive the broadcast and match the received source device unique identifier with the value stored in the memory. The target devices, responsive to the received unique identifier of the source device differing from the associated value stored in the memory, set their active addresses to the default address. In act 804, the target device resets or reconfigures its address to the default address. In one example, the default address is pre-programmed into the target device.

In act 806, the target device receives a command from the master device to generate an identifier. In one example, the command includes information defining the specific range that the identifier value must fall within. The target device proceeds to act 808 and generates the identifier within the range specified in the command from the master device. The identifier value may be generated in part by a random or pseudo-random number generator. Information specific to the target device (e.g., the serial number of the target device) may also be used in the process to reduce the possibility of multiple target devices determining the same identifier. It is appreciated that in some embodiments the serial numbers of the target devices are unique identifiers associated with the die position of the processors on a specific wafer number.

The systems and methods disclosed herein may be applied within a variety of contexts and used with a wide assortment of devices. For instance, in one example, a residential power system employs an automatic address assignment process disclosed herein to assign addresses to current transformers that measure branch circuit currents within a home. In another example, an industrial power system employs an automatic address assignment process to assign address to multiple parallel uninterruptible power supplies. In yet another example, an automobile control system employs an automatic address assignment process to assign addresses to sensors disposed within a car. Other exemplary address assignment processes may provide communications addresses to home automation equipment and displays, security and safe devices, electrical and other energy monitoring devices, power distribution equipment, uninterruptible power supplies, HVAC and other temperature management equipment, lighting control systems, smart or mobile electrical receptacles and appliance control devices. Thus, the exemplary systems and processes disclosed herein are well suited for use within environments that require low cost and highly robust data communications.

Having thus described several aspects of at least one example, it is to be appreciated that various alterations, modifications, and improvements will readily occur to those skilled in the art. For instance, while some embodiments disclosed herein discuss address assignment within a MODBUS network having a shared bus topology, examples may be utilized in other networks having a shared bus topology but employing standards other than MODBUS. For instance, some examples may be utilized in any network having the following characteristics: a shared bus topology, a communications protocol that supports transactions and broadcast communications, communications addresses that do not exceed 8 bits, target devices that have an identifier that does not exceed 244, a source device able to detect the receipt of commands that are determined to be garbled (poorly formed or failing integrity checks) and able to detect and handle response timeouts. Other examples may be utilized in any master-slave network with collision detection. In addition, examples may be implemented between devices connected via a local bus within a single device. Such alterations, modifications, and improvements are intended to be part of this disclosure, and are intended to be within the scope of the examples discussed herein. Accordingly, the foregoing description and drawings are by way of example only.

What is claimed is:

1. A system for assigning communications addresses within a network, the system comprising a memory and at least one processor coupled to the memory and being configured to:
instruct each device of a plurality of devices to generate an identifier by transmitting a message to the plurality of devices using a default address, each device of the plurality of devices having an active address set to the default address;
instruct each device having an identifier within a range of identifiers to transmit a response including the identifier; and
respectively assign a communications address to each device that transmits a response including a unique identifier.

2. The system according to claim 1, wherein the system is further configured to detect a collision on the network responsive to multiple devices of the plurality of devices transmitting responses within a predefined period of time.

3. The system according to claim 2, wherein the range of identifiers includes a first range of identifiers and the system further comprises a second range of identifiers included within the first range of identifiers, wherein the system is further configured to instruct, responsive to detecting the collision, one or more devices having an identifier within the second range of identifiers to transmit a response.

4. The system according to claim 3, wherein the system further comprises a third range of identifiers included within a difference between the first range of identifiers and the second range of identifiers, wherein the system is further configured to instruct, responsive to detecting the collision, one or more devices having an identifier within the third range of identifiers to transmit a response.

5. The system according to claim 1, wherein the system is further configured to instruct, responsive to receiving no response, each device having an identifier within the range of identifiers to transmit a response.

6. The system according to claim 1, wherein the system is further configured to instruct, responsive to multiple devices generating an identical identifier, one or more devices to generate identifiers.

7. The system according to claim 1, wherein the identifier includes at least one of a serial number, a microprocessor identifier, a number generated from a pseudo-random number generator and a number generated from a true random number generator.

8. The system according to claim 1, wherein each device of the plurality of devices comprises:
a memory storing an active address of the device within the network, the active address being set to the default address utilized by at least one other device in data communication with the network; and
at least one processor coupled to the memory and configured to:
receive at least one message sent to the default address including at least one instruction to generate an identifier, transmit the identifier, and change the active address to the communications address;
generate an identifier responsive to receiving the at least one message including the at least one instruction to generate the identifier;
transmit the identifier responsive to receiving the at least one message including the at least one instruction to transmit the identifier; and
set the active address to the communications address responsive to receiving the at least one message including the at least one instruction to change the active address to the communications address.

9. A device comprising:
a memory storing an active address of the device within a network, the active address being set to a default address utilized by at least one other device in data communication with the network; and
at least one processor coupled to the memory and configured to:
receive at least one message sent to the default address including at least one instruction to generate an identifier, transmit the identifier, and change the active address to a communications address;
generate an identifier responsive to receiving the at least one message including the at least one instruction to generate the identifier;
transmit the identifier responsive to receiving the at least one message including the at least one instruction to transmit the identifier; and
set the active address to the communications address responsive to receiving the at least one message including the at least one instruction to change the active address to the communications address.

10. The device according to claim 9, wherein the at least one processor is further configured to set the active address to the default address responsive to detecting a data connection to a new network.

11. The device according to claim 9, wherein the identifier includes at least one of a serial number, a microprocessor identifier, a number generated from a pseudo-random number generator and a number generated from a true random number generator.

12. The device according to claim 10, wherein the identifier is a number and wherein the at least one processor is configured to generate random numbers based at least in part on the microprocessor identifier.

13. The device according to claim 9, wherein the device communicates with one or more systems within the network using the MODBUS protocol.

14. A computer-implemented method of assigning communications addresses using a computer, the computer including a memory and at least one processor coupled to the memory, the method comprising:
instructing, by the computer via a network, each device of a plurality of devices to generate an identifier by transmitting a message to the plurality of devices using a default address, each device of the plurality of devices having an active address set to the default address;
instructing, by the computer via the network, each device having an identifier within a range of identifiers transmit a response including the identifier; and
respectively assigning a communications address to each device that transmits a response including a unique identifier.

15. The computer-implemented method according to claim 14, wherein the method further includes detecting a collision on the network, responsive to multiple devices of the plurality of devices transmitting responses with a predefined period of time.

16. The computer-implemented method according to claim 15, wherein the range of identifiers includes a first range of identifiers and the method further includes instructing, responsive to detecting the collision, one or more devices having an identifier within a second range of identifiers to transmit a response, the second range of identifiers included within the first range of identifiers.

17. The computer-implemented method according to claim 16, wherein the method further includes instructing, responsive to detecting the collision, one or more devices having an identifier within a third range of identifiers to transmit a response, the third range of identifiers included within a difference between the first range of identifiers and the second range of identifiers.

18. The computer-implemented method according to claim 14, wherein the method further includes instructing, responsive to receiving no response, each device having an identifier within the range of identifiers to transmit a response.

19. The computer-implemented method according to claim 14, wherein the method further includes instructing, responsive to multiple devices generating an identical identifier, one or more devices to generate identifiers.

20. The computer-implemented method according to claim 14, wherein instructing each device of the plurality of devices to generate an identifier includes instructing each device of the plurality of devices to generate at least one of a serial number, a microprocessor identifier, a number generated from a pseudo-random number generator and a number generated from a true random number generator.
